(19) United States
(12) Patent Application Publication
(10) Pub. No.: US 2010/0211623 A1
(43) Pub. Date: Aug. 19, 2010

(54) FILTER PROCESSING MODULE AND SEMICONDUCTOR DEVICE

(75) Inventors: Yoshitaka HIRAMATSU, Sagamihara (JP); Hiroaki Nakata, Yokohama (JP); Masakazu Ehama, Sagamihara (JP); Seiji Mochizuki, Kodaira (JP)

Correspondence Address: MILES & STOCKBRIDGE PC, 1751 PINNACLE DRIVE, SUITE 500, MCLEAN, VA, 22102-3833, US

(73) Assignee: RENESAS TECHNOLOGY CORP.

(21) Appl. No.: 12/705,898

(22) Filed: Feb. 15, 2010

(30) Foreign Application Priority Data
Feb. 16, 2009 (JP) 2009-032687

(51) Int. Cl. G06F 17/10; G06F 5/01

(52) U.S. Cl. 708/209; 708/315

(57) ABSTRACT

The present invention is directed to improve efficiency of a filter processing on an image. A filter processing module includes a filter circuit and a control circuit. The filter circuit includes: a first register capable of storing data; a first arithmetic logic unit capable of executing a first filter processing on the basis of output data of the first register; a second register capable of storing a result of the arithmetic operation of the first arithmetic logic unit; and a second arithmetic logic unit capable of executing a second filter processing on the basis of output data of the second register. The control circuit adjusts the number of pieces of data which is input per cycle in the first register in accordance with the number of taps in the first filter processing, size of an execution result of the first filter processing, and the number of second arithmetic logic units, thereby promptly completing the first filter processing.

### CLAIM OF PRIORITY

The present application claims priority from Japanese patent application JP 2009-032687 filed on Feb. 16, 2009, the content of which is hereby incorporated by reference into this application.

### FIELD OF THE INVENTION

The present invention relates to a filter processing technique and, further, to a filter processing module and a semiconductor device to which the technique is applied.

### BACKGROUND OF THE INVENTION

In a filter processing (convolution operation), filter coefficients are sequentially called, each of the read coefficients is subjected to product-sum operation with input data, and results are accumulated, thereby enabling an arithmetic operation of the number of taps exceeding the number of arithmetic logic units to be performed.

For example, patent document 1 discloses a digital filter configured so as not to increase the hardware scale even if the number of taps in a filter to be used increases. According to the technique, a device is controlled on the basis of a written filter coefficient or control data. Therefore, by changing data to be written into a memory, the filer and the sampling rate conversion rate can be changed without increasing the device scale.

### [Patent Document 1]

Japanese Unexamined Patent Publication No. 2001-24479

### SUMMARY OF THE INVENTION

However, when the inventors of the present invention examined the conventional filter processing technique, they found out that the efficiency of a two-dimensional filter processing on two-dimensional data such as an image has to be improved. In the following, an image will be used as an example of the two-dimensional data.

In many cases, the two-dimensional filter processing on an image is performed twice in the horizontal direction and the vertical direction of the image. The flow of processing is as follows. First, data of the number of pieces necessary for the second filter processing is sequentially supplied to a plurality of arithmetic logic units performing a first filter processing and, at the same time, the first filter processing is performed. Results of the first filter processing are sequentially supplied to a plurality of arithmetic logic units corresponding to the second filter processing, and the second filter processing is performed. Consequently, in the case where the number of pieces of data necessary for the second filter processing is larger than the element number of arithmetic logic units performing the first filter processing, the filter processing is performed a plurality of times until the processing on data necessary for the second filter processing is finished. As a result, there is the possibility that the timing of starting the second filter processing delays. In the case where the number of pieces of data necessary for the second filter processing is extremely smaller than the element number of arithmetic logic units performing the first filter processing, the number of arithmetic logic units performing the first filter processing uselessly increases.

The technique described in the patent document 1 does not adjust the number of pieces of data which is input per cycle in accordance with the number of taps of the filter processing and size of data generated by the plural arithmetic logic units simultaneously, and cannot solve the problem.

An object of the present invention is to provide a technique for improving efficiency of a two-dimensional filter processing on two-dimensional data such as an image.

The above and other objects and novel features of the present invention will become apparent from the description of the specification and the appended drawings.

Representative one of inventions disclosed in the application will be briefly described as follows.

A filter processing module includes a filter circuit and a control circuit. The filter circuit includes: a first register capable of storing data; a first arithmetic logic unit capable of executing a first filter processing on the basis of output data of the first register; a second register capable of storing a result of the arithmetic operation of the first arithmetic logic unit; and a second arithmetic logic unit capable of executing a second filter processing on the basis of output data of the second register. The control circuit can adjust the number of pieces of data which is input per cycle in the first register in accordance with the number of taps in the first filter processing, size of an execution result of the first filter processing, and the number of second arithmetic logic units, thereby promptly completing the first filter processing.

An effect obtained by the representative one of the inventions disclosed in the application is briefly described as follows.

That is, according to the present invention, the efficiency of the filter processing on an image can be improved.

### BRIEF DESCRIPTION OF THE DRAWINGS

FIG. 1 is a block diagram showing a configuration example of an image processing apparatus according to a first embodiment of the present invention.

FIG. 2 is a block diagram showing a configuration example of a filter processing unit in the image processing apparatus.

FIG. 3 is a block diagram showing a configuration example of an arithmetic parameter calculating circuit in the filter processing unit illustrated in FIG. 2.

FIG. 4 is an explanatory diagram showing an image necessary for a filter processing, the format of an image stored in a memory, and the format of an image stored in an internal register in the filter processing unit illustrated in FIG. 2.

FIG. 5 is another explanatory diagram showing an image necessary for a filter processing, the format of an image stored in a memory, and the format of an image stored in an internal register in the filter processing unit illustrated in FIG. 2.

FIG. 6 is a block diagram showing another configuration example of the filter processing unit in the image processing apparatus.

FIG. 7 is an explanatory diagram showing an image necessary for a filter processing, the format of an image to be stored in a memory, and the format of an image to be stored in an internal register, in the filter processing unit illustrated in FIG. 6.

FIG. 8 is another explanatory diagram showing an image necessary for a filter processing, the format of an image to be stored in a memory, and the format of an image to be stored in an internal register, in the filter processing unit illustrated in FIG. 6.

FIG. 9 is a block diagram showing a configuration example of a processor according to a third embodiment of the invention.

FIG. 10 is a block diagram showing a configuration example of the filter processing unit in the processor.

FIG. 11 is an explanatory diagram on the format of an image and transfer.

FIG. 12 is a block diagram showing a configuration example of an arithmetic parameter calculating circuit according to a fourth embodiment of the invention.

### DETAILED DESCRIPTION OF THE PREFERRED EMBODIMENTS

### 1. Summary of the Preferred Embodiments

First, outline of representative embodiments of the present invention disclosed in the application will be described. Reference numerals of the drawings referred to in parentheses in the description of the outline of the representative embodiments merely illustrate components designated with the reference numerals included in the concept of the components.

(1) A filter processing module (100) according to a representative embodiment of the invention includes a filter circuit (208) that performs a filter processing on input data, and a control circuit that controls operation of the filter circuit. The filter circuit includes a first register (206) capable of storing input data to the filter processing module (100) and a first arithmetic logic unit (207) capable of executing a first filter processing on the basis of output data of the first register. The filter circuit further includes: a second register (206) capable of storing a result of the arithmetic operation of the first arithmetic logic unit, and a second arithmetic logic unit (207) capable of executing a second filter processing on the basis of output data of the second register. The control circuit can adjust the number of pieces of data which is input per cycle in the first register in accordance with the number of taps in the first filter processing, size of an execution result of the first filter processing, and the number of second arithmetic logic units.

With the configuration, the control circuit adjusts the number of pieces of data which is input per cycle in the first register in accordance with the number of taps in the first filter processing, size of an execution result of the first filter processing, and the number of second arithmetic logic units. Consequently, the first filter processing can be completed promptly, the result of the processing can be supplied to the second filter processing, and the timing of starting the second filter processing can be hastened as compared with the conventional technique.

(2) According to another aspect, the filter circuit may include a first register (206), a first arithmetic logic unit (207), a second register (206), a second arithmetic logic unit (207), and a third register (206). In the first register (206), the above-described data is stored. The first arithmetic logic unit (207) executes a first filter processing on the basis of output data of the first register. In the second register (206), a result of the arithmetic operation of the first arithmetic logic unit is stored. The second arithmetic logic unit (207) executes a second filter processing. In the third register (206), a result of the arithmetic operation of the second arithmetic logic unit is stored.

The control circuit adjusts the number of pieces of data which is input per cycle in the first register in accordance with the number of taps in the first filter processing, size of an execution result of the first filter processing, and the number of second arithmetic logic units. The control circuit adjusts the number of pieces of data which is input per cycle in the second register in accordance with the number of taps in the second filter processing, size of an execution result of the second filter processing, and the number of first arithmetic logic units.

With the configuration, the control circuit adjusts the number of pieces of data which is input per cycle in the first register in accordance with the number of taps in the first filter processing, size of an execution result of the first filter processing, and the number of second arithmetic logic units. Consequently, the first filter processing can be completed promptly, the result of the processing can be supplied to the second filter processing, and the timing of starting the second filter processing can be hastened as compared with the conventional technique. The control circuit also adjusts the number of pieces of data which is input per cycle in the second register in accordance with the number of taps in the second filter processing, size of an execution result of the second filter processing, and the number of first arithmetic logic units. Therefore, the case where the number of pieces of data necessary for the second filter processing is much smaller than the number of the arithmetic logic units performing the first filter processing can be avoided.

(3) In the configuration (2), the control circuit may include an arithmetic parameter calculator (204) capable of calculating an arithmetic parameter, and a control unit (202) that controls operation of the filter circuit on the basis of the arithmetic parameter.

The arithmetic parameter calculator may include a first tap-quantity register (301), a second tap-quantity register (311), a first arithmetic-element-quantity register (312), a second arithmetic-element-quantity register (302), a first output size register (303), a second output size register (313), a first filter processing number-of-times calculator (314), a second filter processing number-of-times calculator (304), a first input size calculator (305), and a second input size calculator (315). The first tap-quantity register (301) holds the number of taps in a first filter processing of an image. The second tap-quantity register (311) holds the number of taps in a second filter processing of an image. The first arithmetic-element-quantity register (312) holds the number of arithmetic logic units for the first filter processing. The second arithmetic-element-quantity register (302) holds the number of arithmetic logic units for the second filter processing. The first output size register (303) holds size of an execution result of the first filter processing. The second output size register (312) holds size of an execution result of the second filter processing. The first filter processing number-of-times calculator (314) calculates the number of times of the first filter processing from the number of taps in the second filter processing, the size of the execution result of the second filter processing, and the number of arithmetic logic units for the first filter processing. The second filter processing number-of-times calculator (304) calculates the number of times of the second filter processing from the number of taps in the first filter processing, the size of the execution result of the first filter processing, and the number of arithmetic logic units for the second filter processing. The first input size calculator (305) calculates the number of pieces of data which is input per cycle to the first register from the number of taps in the first filter processing, the number of times of the second filter processing, and the size of the execution result of the first filter processing. The second input size calculator (315) calculates the number of pieces of data which is input per cycle to the second register from the number of taps in the second filter processing, the number of times of the first filter processing, and the size of the execution result of the second filter processing.

The control unit performs a filter processing in accordance with the number of pieces of data which is input per cycle to the first register, the number of pieces of data which is input per cycle to the second register, the number of times of the first filter processing, and the number of times of the second filter processing.

With the configuration, the first filter processing system and the second filter processing system are provided separately. Consequently, a first input size calculation result and a second input size calculation result can be obtained promptly.

(4) In the configuration (3), the control unit includes a CPU that executes an instruction for instructing update of the first tap-quantity register, the second tap-quantity register, the first output size register, the second output size register, the first arithmetic-element-quantity register, and the second arithmetic-element-quantity register.
(5) In the configuration (2), the filter processing module is coupled to a bus, receives an encoded image via the bus, adjusts the number of pieces of data which is input per cycle to the first register on the basis of a parameter in a stream as the encoded image, and adjusts the number of pieces of data which is input per cycle to the second register.
(6) According to another aspect, a semiconductor device can be configured by including an instruction decoder (1002), an arithmetic parameter calculator (1004), an index generator (1005), an internal register (1006), an arithmetic logic unit (1009), and a data generating circuit (1010). The instruction decoder (1002) decodes an input instruction. The arithmetic parameter calculator (1004) calculates the number of times of the first filter processing, the number of times of the second filter processing, and the number of pieces of data which is input per cycle to an arithmetic logic unit for the first filter processing, and calculates the number of pieces of data which is input per cycle to an arithmetic logic unit for the second filter processing on the basis of a parameter related to a filter processing, given via the instruction decoder. The index generator (1005) generates a corrected source index by correcting a source index fetched via the instruction decoder on the basis of the number of times of the first filter processing or the number of times of the second filter processing calculated by the arithmetic parameter calculator. The internal register (1006) outputs data corresponding to the source index. The arithmetic logic unit (1009) filters data output from the internal register. The data generating circuit (1010) receives an image, converts format of the image on the basis of an arithmetic parameter output from the arithmetic parameter calculator, and supplies the resultant to the internal register.

The arithmetic logic unit includes: a shift register (1007) capable of shifting data output from the internal register; and an SIMD arithmetic logic unit (1008) that computes output data of the shift register.

The arithmetic parameter calculator includes a first tap-quantity register (301), a second tap-quantity register (311), a first arithmetic-element-quantity register (312), a second arithmetic-element-quantity register (302), and a first output size register (303). The arithmetic parameter calculator also includes a second output size register (313), a first the-number-of-filter-processes calculator (314), a second the-number-of-filter-processes calculator (304), a first input size calculator (305), and a second input size calculator (315).

The first tap-quantity register (301) holds the number of taps in a first filter processing of an image. The second tap-quantity register (311) holds the number of taps in a second filter processing of an image. The first arithmetic-element-quantity register (312) holds the number of arithmetic logic units for the first filter processing. The second arithmetic-element-quantity register (302) holds the number of arithmetic logic units for the second filter processing. The first output size register (303) holds size of an execution result of the first filter processing. The second output size register (313) holds size of an execution result of the second filter processing. The first number-of-filter-processes calculator (314) calculates the number of times of the first filter processing from the number of taps in the second filter processing, the size of the execution result of the second filter processing, and the number of arithmetic logic units for the first filter processing. The second number-of-filter-processes calculator (304) calculates the number of times of the second filter processing from the number of taps in the first filter processing, the size of the execution result of the first filter processing, and the number of arithmetic logic units for the second filter processing. The first input size calculator (305) calculates the number of pieces of data which is input per cycle to the first register from the number of taps in the first filter processing, the number of times of the second filter processing, and the size of the execution result of the first filter processing. The second input size calculator (315) calculates the number of pieces of data which is input per cycle to the second register from the number of taps in the second filter processing, the number of times of the first filter processing, and the size of the execution result of the second filter processing.

(7) In the configuration (6), the instruction decoder decodes an instruction which updates at least one of the first tap-quantity register, the second tap-quantity register, the first arithmetic-element-quantity register, the second arithmetic-element-quantity register, the first output size register, and the second output size register.

### 2. Further Detailed Description of the Preferred Embodiments

Embodiments will be described in more details.

In the following, a filter processing in the vertical direction of an image will be described as a vertical filter, and a filter processing in the horizontal direction of an image will be described as a horizontal filter. In the drawings, components assigned with the same reference numeral have the same function.

### FIRST EMBODIMENT

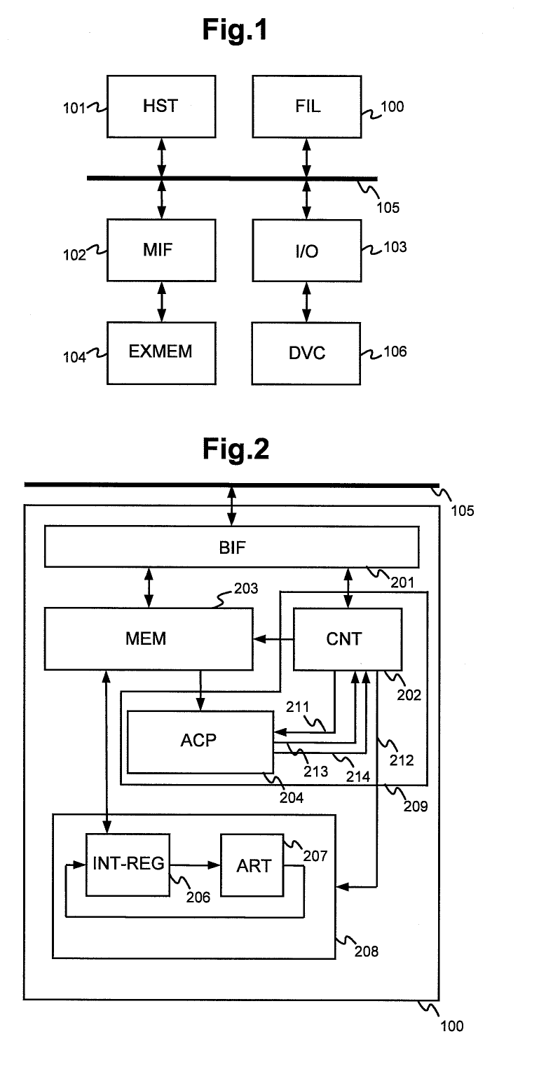

FIG. 1 shows an image processing apparatus according to a first embodiment of the invention.

The image processing apparatus includes a filter processing unit (FIL) 100, a host processor (HST) 101, a memory interface (MIF) 102, an I/O (input/output) circuit 103, and an external memory (EXT-MEM) 104 which are coupled to each other via a bus 105.

The host processor 101 performs a general operation control on the image processing apparatus by executing a predetermined program.

The external memory 104 stores a program to be executed by the host processor 101 and various data, and data is transmitted/received via the bus 105 and the memory interface 102.

The I/O circuit 103 is an interface with a device 106 handling an image, video data, and audio data, and transmits/receives data via the bus 105. Examples of the device coupled to the I/O circuit 103 include a video input device typified by a terrestrial digital tuner, an image input device typified by an image pickup device, and a display device typified by an LCD (Liquid Crystal Display). Video data is input from the video input device, and an image is input from the image input device. On the other hand, an image processed by the image processing apparatus is output to the display device.

The filter processing unit 100 performs a filter processing on an image transmitted via the bus 105. Concretely, the filter processing unit 100 performs an FIR (Finite Impulse Response) filter processing.

FIG. 2 shows a configuration example of the filter processing unit 100.

The filter processing unit 100 includes a bus interface (BIF) 201, a control unit (CTRL) 202, a memory (MEM) 203, an arithmetic parameter calculator (ACP) 204, and a filter circuit 208 and are formed, for example, on a single semiconductor substrate such as a single-crystal silicon substrate. A control circuit 209 is formed by including the control unit (CTRL) 202 and the arithmetic parameter calculator (ACP) 204.

The bus interface 201 transmits/receives various information to/from the host processor 101 coupled to the bus 105. The various information includes images before/after a filter processing and various control information on the filter processing.

The control unit 202 includes, for example, a CPU (Central Processing Unit) executing an instruction given via the bus interface 201, and generates a control signal 211 used for controlling the arithmetic parameter calculating unit 204 and a control signal 212 used for controlling the filter circuit 208. The control unit 202 determines the format of an image transferred to the memory 203 via the bus 105, and sends an instruction to transfer data from the external memory 104 to the bus interface 201.

The memory 203 is used for temporarily storing the number of taps in a filter processing performed by the filter processing unit 100, the size of the result of the arithmetic operation, an image to be subjected to the filter processing, an image subjected to the filter processing, and the like.

The filter circuit 208 includes an internal register (INT-REG) 206 and an arithmetic logic unit (EXE) 207 and performs a filter processing under control of the control unit 202. The internal register 206 receives data for use in the arithmetic processing in the arithmetic logic unit 207 from the memory 203 and holds it. A result of the arithmetic operation of the arithmetic logic unit 207 is written in the internal register 206, and a result of the arithmetic operation held in the internal register 206 is written in the memory 203. The arithmetic logic unit 207 performs, although not limited, an FIR (Finite Impulse Response) filter processing.

The arithmetic parameter calculator 204 receives a parameter related to the filter processing from the memory 203, and calculates the number of times of processing the horizontal filter, the number of times of processing the vertical filter, input size for the horizontal filter processing, and input size for the vertical filter processing. In the following, they will be described as the number of horizontal filter processing times, the number of vertical filter processing times, the horizontal input size, and the vertical input size. A filter processing frequency signal 213 made by the number of horizontal filter processing times and the number of vertical filter processing times and an input size signal 214 made by the horizontal input size and the vertical input size are input to the control unit 202.

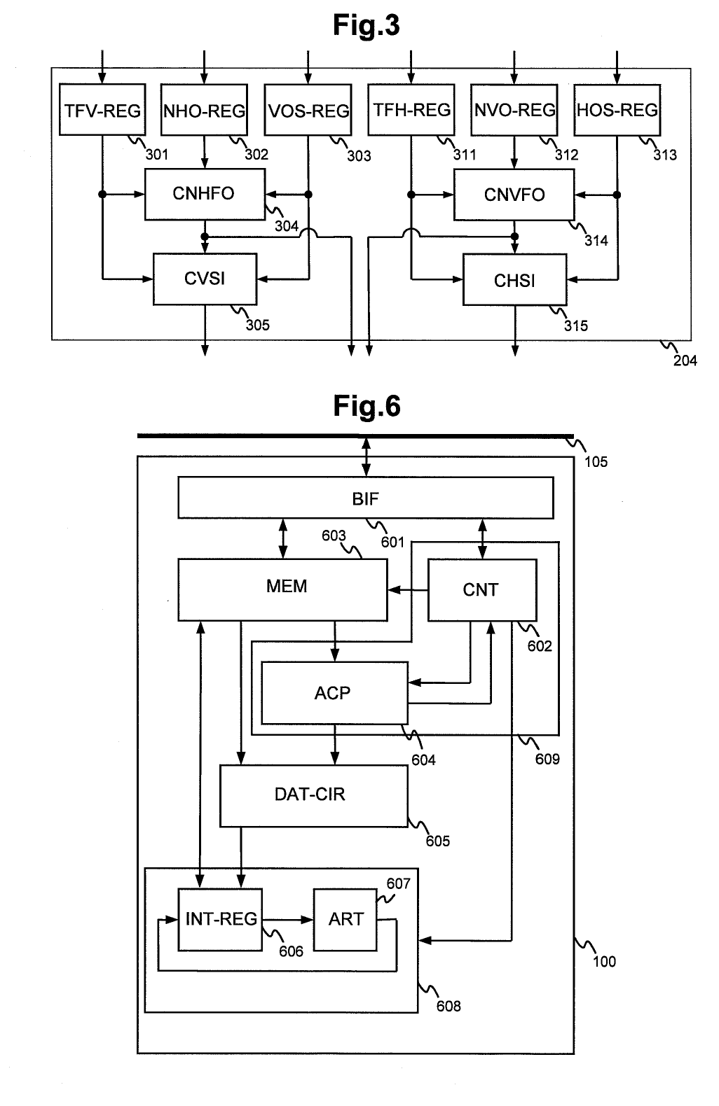

FIG. 3 shows an example of the configuration of the arithmetic parameter calculator 204.

The arithmetic parameter calculator 204 includes a vertical tap quantity register (TFV-REG) 301, a horizontal arithmetic element quantity register (NHO-REG) 302, a vertical output size register (VOS-REG) 303, a unit 304 of calculating the number of horizontal filter processing times (CNHFO), and a vertical input size calculator (CVSI) 305. The arithmetic parameter calculator 204 also includes a horizontal tap quantity register (TFH-REG) 311, a vertical arithmetic element quantity register (NVO-REG) 312, a horizontal output size register (HOS-REG) 313, a unit 314 of calculating the number of vertical filter processing times (CNVFO), and a horizontal input size calculator (CHSI) 305. In the following, the number of vertical taps is expressed as Tᵥ, the number of horizontal arithmetic elements is expressed as Eₕ, vertical output size is expressed as Oᵥ, the number of horizontal taps is expressed as Tₕ, the number of vertical arithmetic elements is expressed as Eᵥ, and the horizontal output size is expressed as Oₕ.

The vertical tap quantity register 301 holds the number of taps in a filter processing in the vertical direction on a two-dimensional image.

The horizontal arithmetic element quantity register 302 holds the number of product-sum operations which can be simultaneously performed in one cycle by the arithmetic logic unit 207 on data in the horizontal direction in a two-dimensional image.

The vertical output size register 303 holds the size of the result of the arithmetic operation of the filter processing in the vertical direction in the two-dimensional image.

The unit 304 for calculating the number of horizontal filter processing times calculates the number Kₕ of times of the filter processing in the horizontal direction necessary to obtain an image of the output size in the horizontal direction. The number of times of the filter processing in the horizontal direction is calculated on the basis of the number of vertical taps, the number of horizontal arithmetic elements, and the vertical output size. In the calculating method, in the case of processing the filter in the horizontal direction first and processing the vertical filter later, when a maximum positive integer K satisfying K(Tᵥ+Oᵥ−1)≦Eₕ exists, 1/K is the number of processing times. When the maximum positive integer K satisfying K(Tᵥ+Oᵥ−1)≦Eₕ does not exist and Tᵥ+Oᵥ/K−1≦Eₕ and the minimum positive integer K satisfying “the remainder of Oᵥ/K=0” exists, K is the number of processing times. On the other hand, in the case of processing the filter in the vertical direction first and processing the filter in the horizontal direction later, when the number of processing times of the vertical filter is expressed as Kᵥ and the maximum positive integer K satisfying K(Oᵥ×Kᵥ)≦Eₕ exists, 1/K is the number of processing times. When the maximum positive integer K satisfying K (Oᵥ×Kᵥ)≦Eₕ does not exist and (Oᵥ×Kᵥ)/K≦Eₕ and the minimum positive integer K satisfying “the remainder of (Oᵥ×Kᵥ)/K=0” exists, K is the number of processing times.

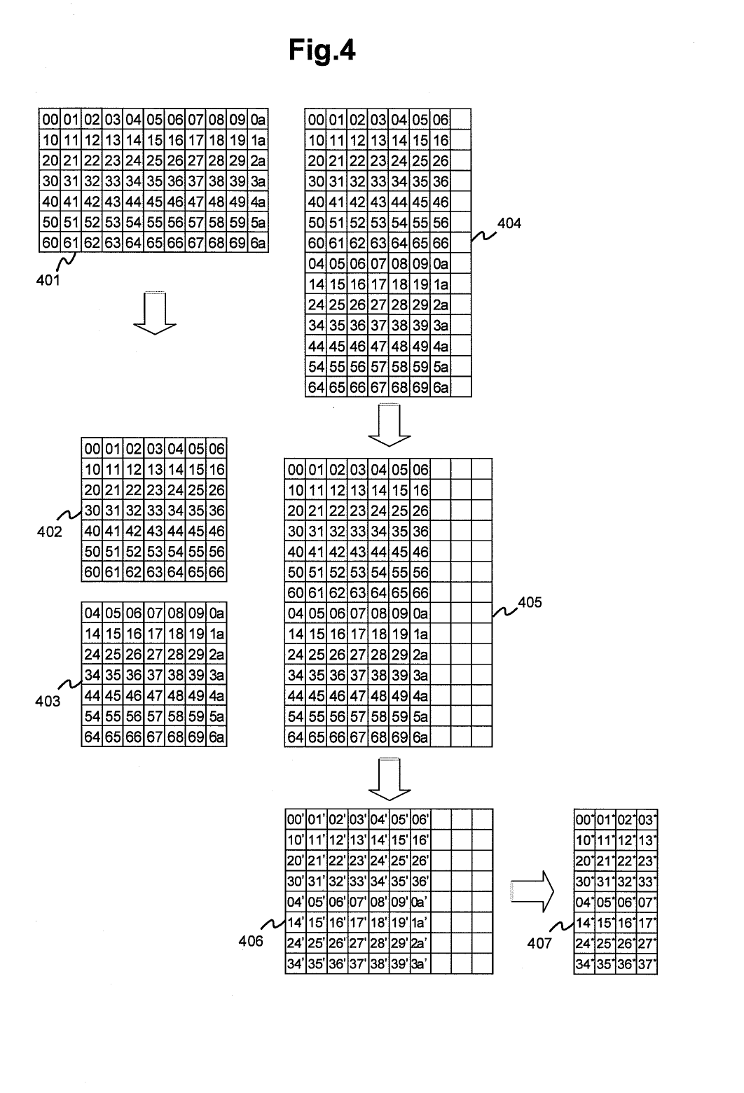

FIG. 4 shows an example of processing a filter in the vertical direction first, having the number of taps Tᵥ=4, the vertical output size Oᵥ=4, the number Eₕ of horizontal arithmetic elements=10, and the number Kᵥ of times of processing the vertical filter=2 and, then, performing the filter processing in the horizontal direction. In the example, the minimum positive integer 1 satisfying K(4×2)≦10 exists, so that the number Kₕ of times of processing the horizontal filter becomes 1.

In the case of processing the filter in the horizontal direction first, which has the number of taps Tᵥ=4, the vertical output size Oᵥ=8 and, then, performing the filter processing in the vertical direction, the maximum positive integer K satisfying K(4+8−1)≦10 does not exist, the minimum positive integer satisfying 2+8/K−1≦10 and the remainder of 8/K=0 is 2, so that the number Kₕ of times of processing the horizontal filter becomes 2.

The vertical input size calculator 305 calculates the size of data which is input in one cycle to the arithmetic logic unit 207 at the time of performing the filter processing in the vertical direction on the basis of the number of vertical taps, the number of times of the horizontal filter processing, and the vertical output size. In the calculating method, when the number Kₕ of times of processing the horizontal filter is equal to or less than 1 (Kₕ≧1), Tᵥ+Oᵥ/Kₕ−1 is set as input data size. When 0<Kₕ<1, (Tᵥ+Oᵥ−1)/Kₕ is set as input data size. In the example of FIG. 4, Kₕ=1, and the vertical input size is 7. In the case of the vertical filter having the number Tᵥ of taps=4 and the vertical output size Oᵥ=8, the vertical input size is 7.

The horizontal tap quantity register 311 holds the number of taps in the filter processing in the horizontal direction in a two-dimensional image.

The vertical arithmetic element quantity register 312 holds the number of product-sum operations which can be simultaneously performed in one cycle by the arithmetic logic unit 207 on data in the vertical direction in the two-dimensional image.

The horizontal output size register 313 holds the size of the result of the arithmetic operation of the filter processing in the horizontal direction in the two-dimensional image.

The unit 314 for calculating the number of times of the horizontal filter processing calculates the number Kₕ of times of the filter processing in the vertical direction necessary to obtain an image of the output size in the vertical direction. The number of times of the filter processing in the vertical direction is calculated on the basis of the number of horizontal taps, the number of vertical arithmetic elements, and the horizontal output size. In the calculating method, in the case of processing the filter in the horizontal direction first and processing the vertical filter later, when the number of times of the processing the horizontal filter is expressed as Kₕ and a maximum positive integer K satisfying K(Oₕ×Kₕ)≦Eᵥ exists, 1/K is the number of processing times. When the maximum positive integer K satisfying K(Oₕ×Kₕ)≦Eᵥ does not exist and (Oₕ×Kₕ)≦Eᵥ and the minimum positive integer K satisfying “the remainder of (Oₕ×Kₕ)/K=0” exists, K is the number of processing times. On the other hand, in the case of processing the filter in the vertical direction first and processing the filter in the horizontal direction later, when the maximum positive integer K satisfying K(Tₕ+Oₕ−1)≦Eᵥ exists, 1/K is the number of processing times. When the maximum positive integer K satisfying K(Tₕ+Oₕ−1)≦Eᵥ does not exist and Tₕ+Oₕ/K−1≦Eᵥ and the minimum positive integer K satisfying “the remainder of Oₕ/K=0” exists, K is the number of processing times.

FIG. 4 shows an example of processing a filter in the vertical direction first, having the number of taps Tₕ=4 of the horizontal filter, the horizontal output size Oₕ=8, and the number Eₕ of horizontal arithmetic elements=10 and, then, performing the filter processing in the horizontal direction. In the example, the minimum positive integer satisfying K(4+8−1)≦10 does not exist but K=2 satisfying 4×8/K−1≦10 and “the remainder of 8/K=0” exists, so that the number Kᵥ of times of processing the vertical/horizontal filter becomes 2.

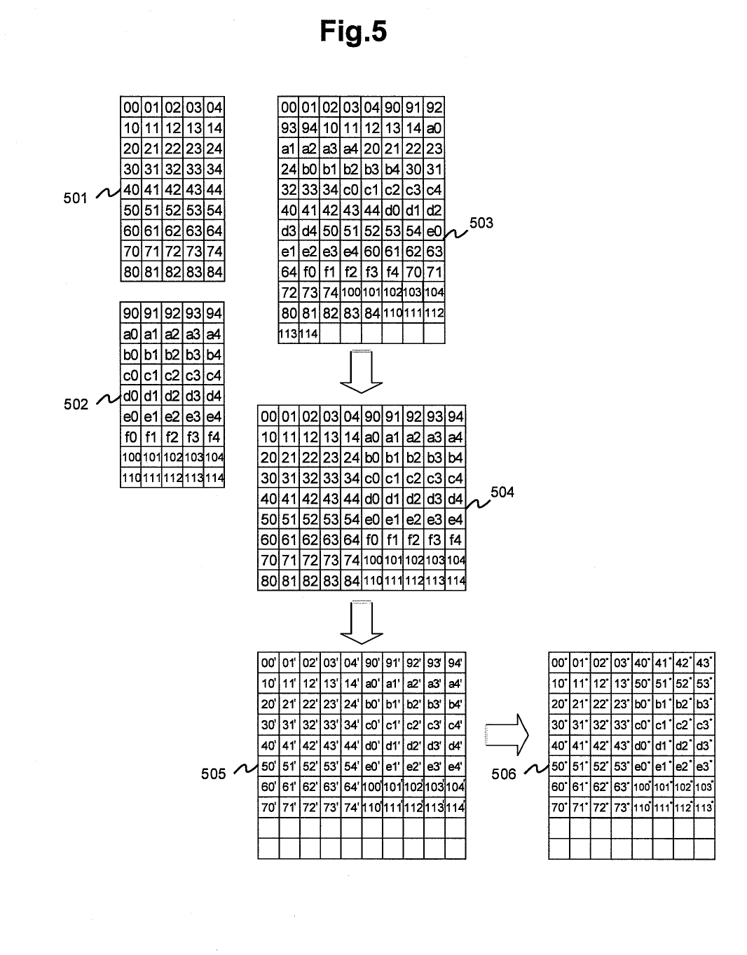

FIG. 5 shows an example of processing a filter in the vertical direction first, having the number of taps Tₕ=2 of the horizontal filter, the horizontal output size Oₕ=4, and the number Eₕ of horizontal arithmetic elements=10 and, then, performing the filter processing in the horizontal direction. In the example, the minimum positive integer K=2 satisfying K(2+4−1)≦10 exists, so that the number Kᵥ of times of processing the vertical filter becomes ½.

The horizontal input size calculator 315 calculates the size of data which is input in one cycle to the arithmetic logic unit 207 at the time of performing the filter processing in the horizontal direction on the basis of the number of horizontal taps, the number of times of the vertical filter processing, and the horizontal output size. In the calculating method, when the number Kᵥ of times of processing the horizontal filter is equal to or less than 1 (Kₕ≧1), Tₕ+Oₕ/Kᵥ−1 is set as input data size. When 0<Kᵥ<1, (Tₕ+Oₕ−1)/Kᵥ is set as input data size.

In the example of FIG. 4, Kᵥ=2, so that the horizontal input size is 7. In the example of FIG. 5, Kₕ=½, so that the horizontal input size is 10.

The flow of the operation in the configuration of the first embodiment is as follows. To determine the format of an image which is input to the memory 203, various information necessary for the filter processing is input to the memory 203. When a start instruction is given from the host processor 101 to the control unit 202 via the bus 105, the filter processing starts in the filter processing unit 100. The control unit 202 sets the number of taps in the horizontal filter, the number of elements in the horizontal filter processing, the horizontal output size, the number of taps in the vertical filter, the number of elements in the vertical filter processing, and the vertical output size in the arithmetic parameter calculator 204. It is also possible to directly write the number of taps in the horizontal filter, the number of elements in the horizontal filter processing, the horizontal output size, the number of taps in the vertical filter, the number of elements in the vertical filter processing, and the vertical output size into the register in the arithmetic parameter calculator 204 without holding them into the memory. After completion of setting the number of taps in the horizontal filter, the number of elements in the horizontal filter processing, the horizontal output size, the number of taps in the vertical filter, the number of elements in the vertical filter processing, and the vertical output size, the arithmetic parameter calculator 204 calculates the number of times of the horizontal filter processing, the horizontal input size, the number of times of the vertical filter processing, and the vertical input size. The arithmetic parameter calculator 204 inputs the filter processing frequency signal 213 made by the number of times of the horizontal filter processing and the number of times of the vertical filter processing and the input size signal 214 made by the horizontal input size and the vertical input size to the control unit 202. The control unit 202 determines the format of an image which is input from the external memory 104 into the memory 203 on the basis of the number of times of the horizontal filter processing input by the filter processing frequency signal 213 and the input size signal 214, the horizontal input size, the number of times of the vertical filter processing, the vertical input size, the number of taps in the horizontal filter, and the number of taps in the vertical filter. The control unit 202 sends the information of the format to the bus interface 201, and the external memory 104 inputs the image in the format into the memory 203 via the bus 105. The image input to the memory 203 is sent to the filter circuit 208, and the filter circuit 208 performs the filter processing, and writes data back into the memory 203.

When an image necessary for the filter processing is I(X,Y) (X denotes a coordinate in the horizontal direction and Y denotes a coordinate in the vertical direction), the number of times of the horizontal filter processing is Kₕ, the horizontal input size is Iₕ, the number of times of the vertical filter processing is Kᵥ, the vertical input size is Iᵥ, the horizontal output size is Oₕ, and the vertical output size is Oᵥ, the format of the image and transfer are performed as follows.

For example, as shown in FIG. 11, in the case where an image 111 is stored in the external memory 104, the image 111 is divided into a plurality of images 111-1 and 111-2 which are transferred to the filter processing unit 100. The size of each of the images 111-1 and 111-2 is determined by vertical input size Iᵥ and horizontal input size Iₕ. The base points 112-1 and 112-2 of the images 111-1 and 111-2 are determined by using the number Kᵥ of times of the vertical filter processing, the number Kₕ of times of the horizontal filter processing, the horizontal output size Oₕ, and the vertical output size Oᵥ. The number Kᵥ of times of the vertical filter processing and the number Kₕ of times of the horizontal filter processing are calculated by the arithmetic parameter calculator 204 and transmitted to the control unit 202. The horizontal output size Oₕ and the vertical output size Oᵥ are values set by the user and given from the host processor 101 to the filter processing unit 100 via the bus 105.

The following nine conditions can be mentioned with respect to the format of the image and the transfer method.

(1) In the case where Kᵥ>1 and Kₕ>1

The format of an image is an image Vⱼₘ (j=0, 1, . . . , Kᵥ−1, m=0, 1, . . . , Kₕ−1) obtained by dividing the image I to Kᵥ×Kₕ. The image Vⱼₘ is an image having a width Iₕ and a height Iᵥ from the coordinates (X, Y)=(j×Oₕ/Kᵥ, m×Oᵥ/Kₕ) on the image I. Transfer is performed in order of V₀₀, V₀₁, . . . , V_{0Kh-1}, . . . , and V_{Kv-1Kh-1}.

(2) In the case where Kᵥ>1 and Kₕ=1

The format of the image is an image Vⱼ (j=0, 1, . . . , Kᵥ−1) obtained by dividing the image I to Kᵥ. The image Vⱼ is an image having a width Iₕ and a height Iᵥ from the coordinates (X, Y)=(j×Oₕ/Kᵥ, O) on the image I. Images are transferred in order of V₀, V₁, . . . , V_{Kv-1}.

(3) In the case where Kᵥ>1 and Kₕ<1

The format of the image is an image Vⱼ (j=0, 1, . . . , Kᵥ−1) obtained by dividing the image I to Kᵥ and coupling 1/Kₕ piece of the divided image in the vertical direction. The image Vⱼ is an image obtained by coupling 1/Kₕ piece of the divided image in the vertical direction. Images are transferred in order of V₀, V₁, . . . , V_{Kv-1}.

(4) In the case where Kᵥ=1 and Kₕ>1

The format of the image is an image Vₘ (m=0, 1, . . . , Kₕ−1) obtained by dividing the image I to Kₕ. The image Vₖ is an image having a width Iₕ and a height Iᵥ from the coordinates (X, Y)=(0, m×Oᵥ/Kₕ) on the image I. Images are transferred in order of V₀, V₁, . . . , V_{Kh-1}.

(5) In the case where Kᵥ=1 and Kₕ=1

The format of the image is an image I, and the image I is transferred.

(6) In the case where Kᵥ=1 and Kₕ<1

The format of the image is an image V obtained by coupling 1/Kₕ piece of the image I, and the image V is transferred.

(7) In the case where Kᵥ<1 and Kₕ>1

The format of the image is an image Vₘ (m=0, 1, . . . , Kₕ−1) obtained by dividing the image I to Kₕ and coupling 1/Kᵥ piece in the horizontal direction. The image Vₘ is an image obtained by coupling 1/Kv piece of an image having a width Iₕ×Kv and a height Iᵥ from the coordinates (X, Y)=(0, m×Oᵥ/Kₕ) on the image I. Images are transferred in order of V₀, V₁, . . . , V_{Kh-1}.

(8) In the case where Kᵥ<1 and Kₕ=1

The format of the image is an image V obtained by coupling 1/Kv piece of the image I in the horizontal direction, and the image V is transferred.

(9) In the case where Kᵥ<1 and Kₕ<1

The format of the image is an image V obtained by coupling 1/Kₕ piece of the image I in the vertical direction and coupling 1/Kᵥ piece in the horizontal direction, and the image V is transferred.

FIG. 4 shows an example of an image necessary for a filter processing, a format of an image stored in the memory 203, and a format of an image stored in the internal register 206. FIG. 4 shows an example of processing a filter in the vertical direction first, and processing a filter in the horizontal direction later. In a horizontal filter, the number Tₕ of taps is 4, the number Eₕ of horizontal arithmetic elements is 10, and horizontal output size Oₕ is 8. In a vertical filter, the number Tᵥ of taps is 4, the number Eᵥ of vertical arithmetic elements is 10, and vertical output size Oᵥ is 4. From the arithmetic parameter calculator 204, the number Kₕ of times of the horizontal filter processing is 1, the number Kᵥ of times of the vertical filter processing is 2, the horizontal input size Iₕ is 7, and the vertical input size Iᵥ is 7. The format of an image and the transfer method correspond to the condition (2). The formats of images transferred from the external memory 104 to the memory 203 are an image 402 having a width of 7 and a height of 7 from the coordinates (X, Y)=(0,0) on an image 401 having a width 11 and a height 7 necessary to generate an image of Oₕ=8 and Oᵥ=4, and an image 403 having a width 7 and a height 7 from the coordinates (X, Y)=(4,0) on the image 401. On the memory 203, data in the format of an image 404 is stored, which is obtained by adding invalid data of one pixel in the horizontal direction to each of the images 402 and 403 so that the width becomes 8 bytes and arranging the images 402 and 403 in order. In the internal register, 10 pixels are stored as one entry. As shown in an image 405, the images 402 and 403 are stored in total 14 entries. After the images 402 and 403 are stored in the internal register 206, a filter processing of four taps is performed in the vertical direction by the arithmetic logic unit 207, and the result of the arithmetic operation is input as the format of an image 406 to the internal register. After the vertical filter processing is performed, a filter processing of four taps is performed in the horizontal direction of the result (the image 406) of the vertical filter processing, and the result of the arithmetic operation is stored in the form of an image 406 in the internal register 206.

FIG. 5 shows an example of an image necessary for a filter processing, a format of an image stored in the memory 203, and a format of an image stored in the internal register 206. FIG. 5 shows an example of processing a filter in the vertical direction first, and processing a filter in the horizontal direction later. In a horizontal filter, the number Tₕ of taps is 2, the number Eₕ of horizontal arithmetic elements is 10, and horizontal output size Oₕ is 4. In a vertical filter, the number Tᵥ of taps is 2, the number Eᵥ of vertical arithmetic elements is 10, and vertical output size Oᵥ is 8. From the arithmetic parameter calculator 204, the number Kₕ of times of the horizontal filter processing is 1, the number Kᵥ of times of the vertical filter processing is ½, the horizontal input size Iₕ is 10, and the vertical input size Iᵥ is 9. The format of an image and the transfer method correspond to the condition (8). The formats of images transferred from the external memory 104 to the memory 203 are images 501 and 502 each having a width of 5 and a height of 9 necessary to generate an image of Oₕ=4 and Oᵥ=8. In the memory 203, an image 503 in the format obtained by coupling the images 501 and 502 is stored. In the internal register, data of 10 pixels is stored as one entry. As shown in an image 504, the images 501 and 502 are stored in total nine entries. After the images 501 and 502 are stored in the internal register, a filter processing of four taps is performed in the vertical direction by the arithmetic logic unit 207, and the result of the arithmetic operation is stored in the format of an image 505 to the internal register. A filter processing of four taps is performed in the horizontal direction on the result of the arithmetic operation (the image 505), and the result of the arithmetic operation is stored in the form of an image 506 in the internal register 206.

According to the conventional technique, data of the number of pieces necessary for the second filter processing is sequentially supplied to a plurality of product-sum operation units. The first filter processing is performed simultaneously on the data. The result of the first filter processing is sequentially supplied to the product-sum operation units and the second filter processing is performed simultaneously on the data. Consequently, in the case where the amount of data necessary for the second filter processing is larger than the number of elements of the operation units performing the first filter processing, for example, in the case where the number of arithmetic elements performing the first filter processing is eight and data which is input in relation with data necessary for the second filter processing is 11 pixels, the data of 11 pixels has to be divided to eight pixels and three pixels, and the filter processing has to be performed twice. As a result, until the arithmetic operation on data necessary for the second filter processing is completed, cycles necessary to perform the filter processing twice are required. There is consequently the possibility that the timing of starting the second filter processing delays. The delay in the timing of starting the second filter processing disturbs reduction in time necessary for the filter processing on a two-dimensional image.

In contrast, in the first embodiment, the number of pieces of data which is input per cycle into the first register is adjusted according to the number of taps in the filter processing and size of data generated simultaneously by the plural arithmetic logic units (the number of arithmetic elements), thereby promptly completing the first filter processing and supplying the result to the second filter processing. It can hasten the timing of starting the second filter processing. For example, as shown in FIG. 4 (corresponding to the condition (2)), the image transferred from the external memory 104 to the memory 203 is divided from the image 401 having width 11 and height 7 necessary to generate an image of Oₕ=8 and Oᵥ=4 to two images; the image 402 having width 7 and height 7 from the coordinates (X,Y)=(0,0) on the image 401 and the image 403 having width 7 and height 7 from the coordinates (X,Y)=(4,0) on the image 401. As a result, the number of pieces of data necessary for the second filter processing becomes seven, and the number of pieces of data which is input per cycle to the first register becomes seven. Thus, the first filter processing can be completed promptly, and the result can be provided to the second filter processing.

By adjusting the number of pieces of data which is input per cycle to the first register in accordance with the number of taps in the second filter processing, the size of the execution result of the second filter processing, and the number of arithmetic logic units performing the first filter processing, the case where the number of arithmetic logic units uselessly performing the first filter processing can be avoided. For example, as shown in FIG. 5 (corresponding to the condition (8)), an image transferred from the external memory 104 to the memory 203 becomes from the image 501 having width 5 and height 9 necessary to generate an image of Oₕ=4 and Oᵥ=8 to an image obtained by coupling the images 501 and 502. As a result, the number of pieces of data which is input per cycle to the first register becomes 10. Thus, arithmetic operations corresponding to the size of data which can be generated simultaneously by the arithmetic logic units performing the first filter processing are performed simultaneously, so that waste is eliminated.

According to the first embodiment, the following effects can be obtained.

By adjusting the number of pieces of data which is input per cycle to the first register in accordance with the number of taps in the filter processing and the size of data simultaneously generated by a plurality of arithmetic logic units, the first filter processing is completed promptly, and the result of the first filter processing can be provided to the second filter processing. It can hasten the timing of starting the second filter processing as compared with that of the conventional technique. Since the number of pieces of data which is input per cycle to the first register is adjusted according to the number of taps in the second filter processing, the size of the execution result of the second filter processing, and the number of arithmetic logic units performing the first filter processing, useless arithmetic operations by the arithmetic logic units performing the first filter processing can be reduced.

Thus, the two-dimensional filter processing on a two-dimensional image can be performed efficiently.

### SECOND EMBODIMENT

FIG. 6 shows a configuration example of the filter processing unit 100 according to a second embodiment of the invention.

The configuration shown in FIG. 6 is similar to that of the filter processing unit illustrated in FIG. 2 but is different from that of FIG. 2 with respect to the point that a data generating circuit (DATA-CIR) 605 is provided and, at the time of transferring an image stored in the memory 603 to a filter circuit 608, the data format is converted by the data generating circuit 605. In FIG. 6, a control circuit 609 is formed by including a control unit 602 and an arithmetic parameter calculating unit 604.

The data generating circuit 605 receives an image stored in the memory 603 on the basis of arithmetic parameters calculated by the arithmetic parameter calculating unit 604, converts the format of the image, and transfers the resultant image to the filter circuit 608.

The flow of operations in the configuration of the second embodiment is as follows. First, images transferred via the bus 105 and various information necessary for the filter processing are stored into the memory 603 via a bus interface 601. When a start instruction is given from the host processor 101 to the control unit 602 via the bus 105, the filter processing starts in the filter processing unit 100. The control unit 602 sets the number of taps in the horizontal filter, the number of elements in the horizontal filter processing, the horizontal output size, the number of taps in the vertical filter, the number of elements in the vertical filter processing, and the vertical output size in the arithmetic parameter calculator 604. It is also possible to directly write the number of taps in the horizontal filter, the number of elements in the horizontal filter processing, the horizontal output size, the number of taps in the vertical filter, the number of elements in the vertical filter processing, and the vertical output size into the register in the arithmetic parameter calculator 604 without storing them in the memory 603. After completion of setting the number of taps in the horizontal filter, the number of elements in the horizontal filter processing, the horizontal output size, the number of taps in the vertical filter, the number of elements in the vertical filter processing, and the vertical output size, the arithmetic parameter calculator 604 calculates the number of times of the horizontal filter processing, the horizontal input size, the number of times of the vertical filter processing, and the vertical input size, and sends them to the data generating circuit 605. The data generating circuit 605 determines the format of an image which is input to the filter circuit 608 on the basis of the number of times of the horizontal filter processing, the horizontal input size, the number of times of the vertical filter processing, the vertical input size, the number of taps in the horizontal filter, and the number of taps in the vertical filter which are input, converts the format of an image which is input to the filter circuit 608, converts the image according to the format, and transfers the resultant image to the filter circuit 608. The format of an image is similar to that of the first embodiment. The filter circuit 606 performs the filter processing and writes the data back to the memory 603.

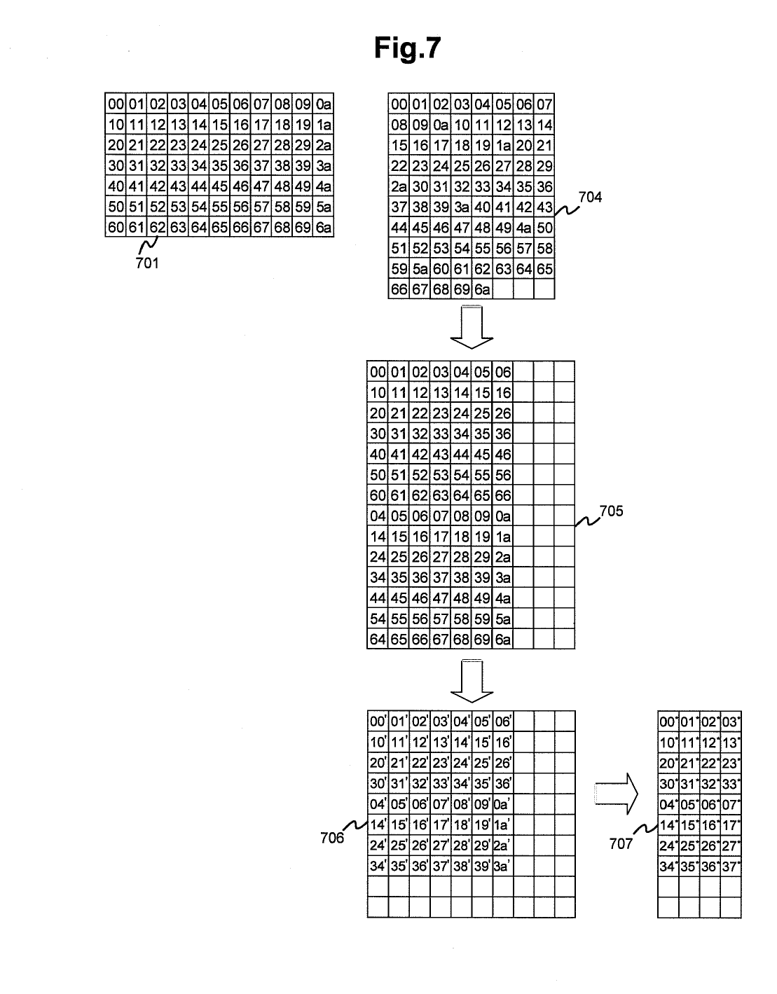

FIG. 7 shows an example of an image necessary for the filter processing in the case of the condition (2) in the second embodiment, the format of the image stored in the memory 603, and the format of the image stored in the internal register 606. The difference between the example of FIG. 7 and that of FIG. 4 is as follows. In FIG. 4, the image is stored in the format optimum to the filter processing at the time point where the image is stored in the memory 203. On the other hand, in FIG. 7, the image is stored in the format optimum to the filter processing in the internal register. Images 701, 704, 705, 706, and 707 in FIG. 7 correspond to the images 401, 404, 405, 406, and 407 in FIG. 4, respectively.

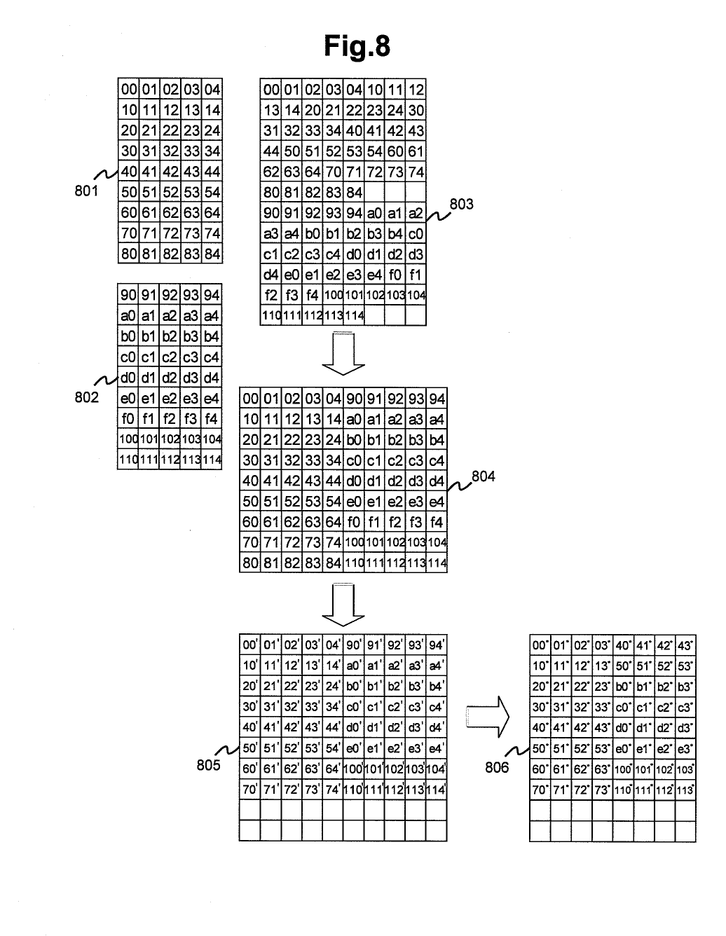

FIG. 8 shows an example of an image necessary for the filter processing in the case of the condition (8) in the second embodiment, the format of the image stored in the memory 603, and the format of the image stored in the internal register 606. The difference between the example of FIG. 8 and that of FIG. 5 is as follows. In FIG. 5, the image is stored in the format optimum to the filter processing at the time point where the image is stored in the memory 203. On the other hand, in FIG. 8, the image is stored in the format optimum to the filter processing in the internal register. Images 801, 802, 803, 804, 805, and 806 in FIG. 8 correspond to the images 501, 502, 503, 504, 505, and 506 in FIG. 5, respectively.

In the second embodiment, by transferring the original image to the memory 603 in the filter processing unit 100, the size becomes smaller than that in the case of transferring divided images.

### THIRD EMBODIMENT

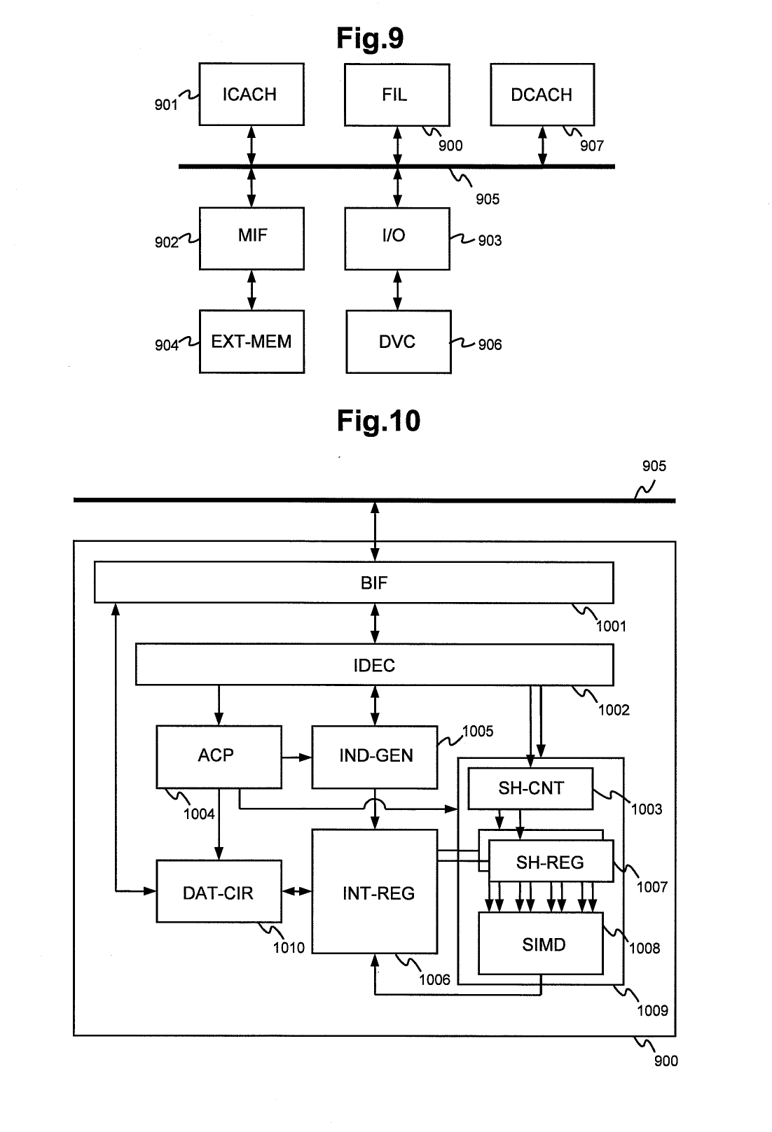

FIG. 9 shows a processor according to a third embodiment of the invention.

The processor shown in FIG. 9 is an example of the semiconductor device and is formed on a single semiconductor substrate such as a single-crystal silicon substrate by the known semiconductor integrated circuit technique.

The processor shown in FIG. 9 includes a filter processing unit (FIL) 900, an instruction cache (ICACHE) 901, a memory interface (MIF) 902, an I/O (input/output) circuit 903, an external memory (EXT-MEM) 904, and a data cache 907 which are coupled to each other via a bus 905.

The filter processing unit 900 performs a predetermined arithmetic processing by executing an instruction fetched via the instruction cache 901. In the case of outputting the result of the arithmetic operation by a store instruction or the like, the result is temporarily held in the data cache 907 or is held in the external memory 904 via the bus 905 and the memory interface 902. The result can be also transmitted to the I/I circuit 903 as an interface to devices of video and audio data via the bus 905. Examples of the devices coupled to the I/O circuit 903 include a video input device typified by a terrestrial digital tuner, an image input device typified by an image pickup device, and a display device typified by an LCD.

FIG. 10 shows a configuration example of the filter processing unit 900 according to the third embodiment of the invention.

The filter processing unit 900 includes a bus interface (BIF) 1001, an instruction decoder (IDEC) 1002, an arithmetic parameter calculator (ACP) 1004, an index generator (IND-GEN) 1005, an internal register (INT-REG) 1006, a filter processor 1009, and a data generation circuit (DATA-CIR) 1010.

The instruction decoder 1002 decodes an input instruction, thereby generating parameter signals related to the filter processing, a source index, and a filter processing control signal. The parameters related to the filter processing are, concretely, the number of vertical taps, the number of horizontal arithmetic elements, vertical output size, the number of times in horizontal filter processing, vertical input size, the number of horizontal taps, the number of vertical arithmetic elements, horizontal output size, the number of times in vertical filter processing, and horizontal input size.

On the basis of the parameters related to the filter processing input from the instruction decoder 1002, the arithmetic parameter calculator 1004 calculates the number of times of the filter processing in the horizontal direction in a two-dimensional image and the number of times of the filter processing in the vertical direction. On the basis of the parameters related to the filter processing input from the instruction decoder 1002, the arithmetic parameter calculator 1004 calculates the size in the horizontal direction of the two-dimensional image which is input per cycle to the arithmetic logic unit calculating the filter processing in the horizontal direction and the size in the horizontal direction of the two-dimensional image which is input per cycle to the arithmetic logic unit calculating the filter processing in the horizontal direction. The arithmetic parameter calculator 1004 sends the number of times of the horizontal filter processing and the number of times of the vertical filter processing to the filter processor 1009 and sends the horizontal input data size and the vertical input data size to the data generation circuit 1010. The arithmetic parameter calculator 1004 has a configuration similar to that of FIG. 3. In this case, an instruction for updating at least one of the vertical tap-quantity register 301, the horizontal arithmetic-element-quantity register 302, the vertical output size register 303, the horizontal tap-quantity register 311, the vertical arithmetic-element-quantity register 312, and the horizontal output size register 313 in the arithmetic parameter calculator 1004 is decoded by the instruction decoder 1002. By the operation, the corresponding register is updated.

On start of the filter processing, the index generator 1005 generates a corrected source index by correcting a source index which is input via the instruction decoder 1002 on the basis of the number of times of the horizontal filter processing and the number of times of the vertical filter processing input from the arithmetic parameter calculator 1004, and holds it on the inside. During the filter processing, the index generator 1005 increments the corrected source index.

The internal register 1006 holds data fetched as data to be subject to the filter processing and outputs data corresponding to the corrected source index which is input from the index generator 1005.

The filter processor 1009 has, although not limited, a shift register (SFT-REG) 1007 capable of shifting data, a shift control circuit (SFT-CTRL) 1003 controlling data shift in the shift register 1007, and an SIMD arithmetic unit 1008 performing an arithmetic processing on output data of the internal register 1006. SIMD stands for Single Instruction Multiple Data. An SIMD arithmetic operation denotes an arithmetic method of performing a processing on a plurality of pieces of data by a single instruction. A result of the arithmetic operation in the SIMD arithmetic unit 1008 is written in the internal register 1006. The filter processor 1009 performs a filter processing by the number of times of the filter processing input from the arithmetic parameter calculator 1004.

The data generation circuit 1010 receives an image stored in the external memory 904 or the data cache 907, converts the image format on the basis of the arithmetic parameters input from the arithmetic parameter calculator 1004, and transfers the resultant image to the internal register 1006. The format of the image is similar to that determined by the control unit 202 in the first embodiment.

In the configuration, in the case where a filter processing is instructed by a command which is entered to the instruction decoder 1002, first, a source index as a base point of data to be read which is stored in the internal register is supplied from the instruction decoder 1002 to the index generator 1005. Various parameters related to the filter processing are supplied from the instruction decoder 1002 to the arithmetic parameter calculator 1004. In a manner similar to the first and second embodiments, the arithmetic parameter calculator 1004 calculates the number of times of the horizontal filer processing, the horizontal input size, the number of times of the vertical filter processing, and the vertical input size, enters all of the parameters to the data generating circuit 1010, and enters the number of times of the horizontal filter processing and the number of times of the vertical filter processing to the index generator 1005. The index generator 1005 calculates the corrected source index on the basis of the number of times of the horizontal filter processing, the number of times of the vertical filter processing, and the source index, and enters them to the internal register 1006. The internal register 1006 inputs data of a register corresponding to the corrected source index to the shift register 1007 in the filter processor 1009. The shift register 1007 shifts data by the shift control circuit 1003 or inputs data from the internal register 1006. The case of shifting data of the shift register corresponds to the case of the horizontal filter processing. The data from the shift register 1007 is supplied to the SIMD arithmetic unit 1008. The result of the arithmetic operation is written in the internal register 1006, and the filter processing is completed.

Also in the semiconductor device with the above-described configuration, in a manner similar to the first and second embodiments, the arithmetic parameter calculator 1004 calculates the number of times of the horizontal filter processing, the horizontal input size, the number of times of the vertical filter processing, and the vertical input size. On the basis of the parameters calculated by the arithmetic parameter calculator 1004, the filter processing is performed in the filter processor 1009. At this time, the circuit 1010 receives the image stored in the external memory 904 or the data cache 907, converts the image format on the basis of the arithmetic parameters entered from the arithmetic parameter calculator 1004, and transfers the resultant image to the internal register 1006. Since the format of the image is similar to that determined by the control unit 202 in the first embodiment, the number of pieces of data which is input per cycle to the internal register 1006 can be adjusted in accordance with the number of taps in the first filter processing, the size of the execution result of the first filter processing, and the number of the second arithmetic logic units. The number of pieces of data which is input per cycle to the internal register 1006 can be also adjusted in accordance with the number of taps in the second filter processing, the size of the execution result of the second filter processing, and the number of the first arithmetic logic units. Consequently, also in the filter processing unit 900, effects similar to those of the first and second embodiments can be obtained.

### FOURTH EMBODIMENT

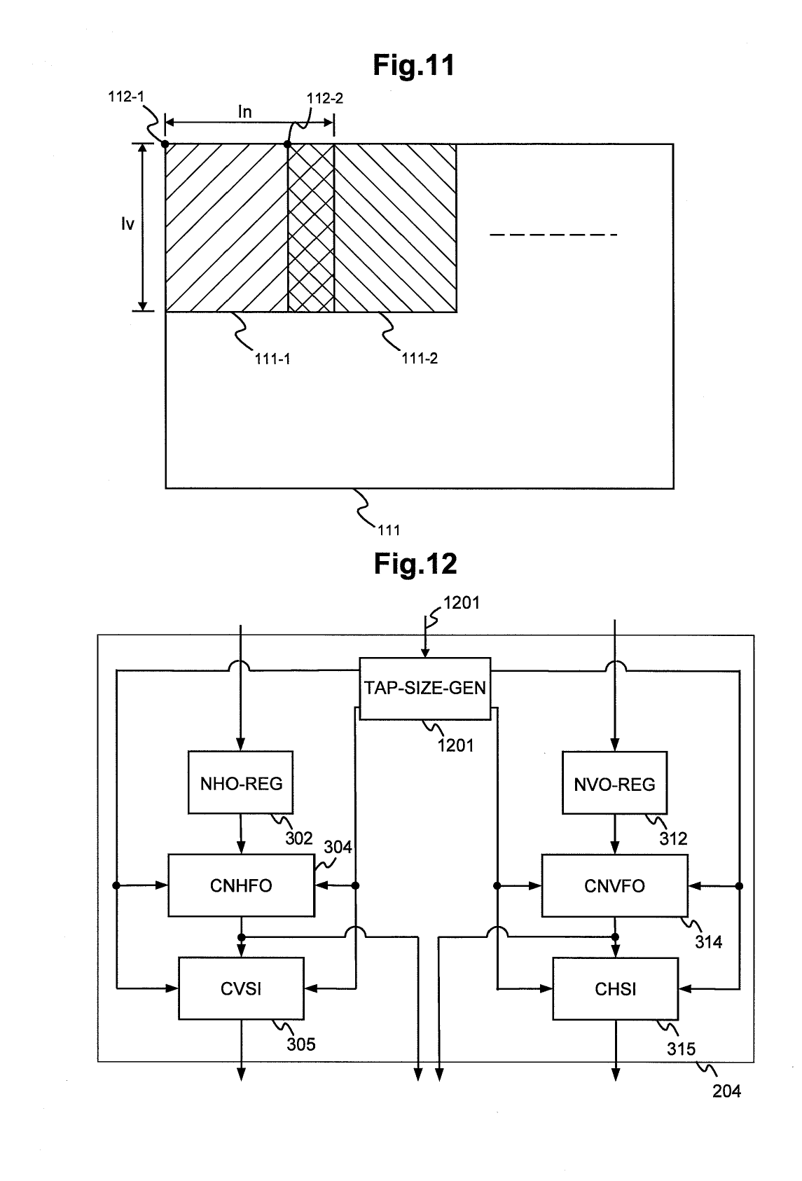

FIG. 12 shows another configuration example of the arithmetic parameter calculator 204.

The arithmetic parameter calculator 204 shown in FIG. 12 differs from that in FIG. 3 with respect to the point that a tap-quantity and output size generator 1201 sets the number of vertical taps, the vertical output size, the number of horizontal taps, and the horizontal output size by using encoding information 1200.

For example, in motion predicting processing in a brightness image of MPEG1 and MPEG2, the number of vertical taps is two, the number of horizontal taps is two, the vertical output size is eight, and the horizontal output size is eight. In an encoding method called VC-1 (WMV9), in the case of using the bicubic method for the motion predicting processing, the number of vertical taps is four, the number of horizontal taps is four, the vertical output size is eight, and the horizontal output size is eight.

According to the fourth embodiment, signals output from the outside are not the number of vertical taps, the vertical output size, the number of horizontal taps, and the horizontal output size. The method 1200 is determined in the filter processing circuit, and the number of vertical taps, the vertical output size, the number of horizontal taps, and the horizontal output size can be set. Only by the encoded image and the encoding information, effects similar to those of the first and second embodiments can be obtained.

The present invention achieved by the inventors herein has been concretely described above. Obviously, the invention is not limited to the embodiments but can be variously modified without departing from the gist.

For example, in the foregoing embodiments, each of the first, second, and third registers in the present invention is formed by the internal register 206. However, the first, second, and third registers may be formed by different registers. Although each of the first and second arithmetic logic units in the invention is formed by the arithmetic logic unit 207 in the foregoing embodiments, the first and second arithmetic logic units may be formed by different arithmetic logic units.

As the filter processing unit 900 in FIG. 9, the configuration shown in FIG. 2 may be employed.

What is claimed is:

1. A filter processing module comprising:
a filter circuit that performs a filter processing on input data; and
a control circuit that controls operation of the filter circuit,
wherein the filter circuit comprises:
a first register capable of storing input data to the filter processing module;
a first arithmetic logic unit capable of executing a first filter processing on the basis of output data of the first register;
a second register capable of storing a result of the arithmetic operation of the first arithmetic logic unit; and
a second arithmetic logic unit capable of executing a second filter processing on the basis of output data of the second register, and
wherein the control circuit can adjust the number of pieces of data which is input per cycle in the first register in accordance with the number of taps in the first filter processing, size of an execution result of the first filter processing, and the number of second arithmetic logic units.

2. A filter processing module comprising:
a filter circuit that performs a filter processing on input data; and
a control circuit that controls operation of the filter circuit,
wherein the filter circuit comprises:
a first register capable of storing input data to the filter processing module;
a first arithmetic logic unit capable of executing a first filter processing on the basis of output data of the first register;
a second register capable of storing a result of the arithmetic operation of the first arithmetic logic unit;
a second arithmetic logic unit capable of executing a second filter processing on the basis of output data of the second register; and
a third register that stores a result of the arithmetic operation of the second arithmetic logic unit, and
wherein the control circuit adjusts the number of pieces of data which is input per cycle in the first register in accordance with the number of taps in the first filter processing, size of an execution result of the first filter processing, and the number of second arithmetic logic units, and adjusts the number of pieces of data which is input per cycle in the second register in accordance with the number of taps in the second filter processing, size of an execution result of the second filter processing, and the number of first arithmetic logic units.

3. The filter processing module according to claim 2,
wherein the control circuit comprises:
an arithmetic parameter calculator capable of calculating an arithmetic parameter; and
a control unit that controls operation of the filter circuit on the basis of the arithmetic parameter,
wherein the arithmetic parameter calculator comprises:
a first tap-quantity register that holds the number of taps in a first filter processing of an image;
a second tap-quantity register that holds the number of taps in a second filter processing of an image;
a first arithmetic-element-quantity register that holds the number of arithmetic logic units for the first filter processing;
a second arithmetic-element-quantity register that holds the number of arithmetic logic units for the second filter processing;
a first output size register that holds size of an execution result of the first filter processing;
a second output size register that holds size of an execution result of the second filter processing;
a first filter processing number-of-times calculator that calculates the number of times of the first filter processing from the number of taps in the second filter processing, the size of the execution result of the second filter processing, and the number of arithmetic logic units for the first filter processing;
a second filter processing number-of-times calculator that calculates the number of times of the second filter processing from the number of taps in the first filter processing, the size of the execution result of the first filter processing, and the number of arithmetic logic units for the second filter processing;
a first input size calculator that calculates the number of pieces of data which is input per cycle to the first register from the number of taps in the first filter processing, the number of times of the second filter processing, and the size of the execution result of the first filter processing; and
a second input size calculator that calculates the number of pieces of data which is input per cycle to the second register from the number of taps in the second filter processing, the number of times of the first filter processing, and the size of the execution result of the second filter processing, and
wherein the control unit performs a filter processing in accordance with the number of pieces of data which is input per cycle to the first register, the number of pieces of data which is input per cycle to the second register, the number of times of the first filter processing, and the number of times of the second filter processing.

4. The filter processing module according to claim 3,
wherein the control unit comprises a CPU that executes an instruction for instructing update of the first tap-quantity register, the second tap-quantity register, the first output size register, the second output size register, the first arithmetic-element-quantity register, and the second arithmetic-element-quantity register.

5. The filter processing module according to claim 2,
wherein the arithmetic parameter calculator comprises:
a tap-quantity and output-size calculator that calculates the number of taps in the first filter processing, the number of taps in the second filter processing, the size of the execution result of the first filter processing, and the size of the execution result of the second filter processing from an encoding format of an encoded image;
a first arithmetic-element-quantity register that holds the number of arithmetic logic units for the first filter processing;
a second arithmetic-element-quantity register that holds the number of arithmetic logic units for the second filter processing;
a first filter-process-number calculator that calculates the number of times of the first filter processing from the number of taps in the second filter processing, the size of the execution result of the second filter processing, and the number of arithmetic logic units for the first filter processing;
a second filter-process-number calculator that calculates the number of times of the second filter processing from the number of taps in the first filter processing, the size of the execution result of the first filter processing, and the number of arithmetic logic units for the second filter processing;
a first input size calculator that calculates the number of pieces of data which is input per cycle to the first register from the number of taps in the first filter processing, the number of times of the second filter processing, and the size of the execution result of the first filter processing; and
a second input size calculator that calculates the number of pieces of data which is input per cycle to the second register from the number of taps in the second filter processing, the number of times of the first filter processing, and the size of the execution result of the second filter processing, and
wherein the control unit performs a filter processing in accordance with the number of pieces of data which is input per cycle to the first register, the number of pieces of data which is input per cycle to the second register, the number of times of the first filter processing, and the number of times of the second filter processing.

6. The filter processing module according to claim 2,
wherein the filter processing module is coupled to a bus, receives an encoded image via the bus, adjusts the number of pieces of data which is input per cycle to the first register on the basis of a parameter in a stream as the encoded image, and adjusts the number of pieces of data which is input per cycle to the second register.

7. A semiconductor device comprising:
an instruction decoder that decodes an input instruction;
an arithmetic parameter calculator that calculates the number of times of the first filter processing, the number of times of the second filter processing, and the number of pieces of data which is input per cycle to an arithmetic logic unit for the first filter processing, and calculates the number of pieces of data which is input per cycle to an arithmetic logic unit for the second filter processing on the basis of a parameter related to a filter processing, given via the instruction decoder;
an index generator that generates a corrected source index by correcting a source index fetched via the instruction decoder on the basis of the number of times of the first filter processing and the number of times of the second filter processing calculated by the arithmetic parameter calculator;
an internal register that outputs data corresponding to the source index;
an arithmetic logic unit that filters data output from the internal register; and
a data generating circuit that receives an image, converts format of the image on the basis of an arithmetic parameter output from the arithmetic parameter calculator, and supplies the resultant to the internal register,
wherein the arithmetic logic unit comprises:
a shift register capable of shifting data output from the internal register; and
an SIMD arithmetic unit that computes output data of the shift register,
the arithmetic parameter calculator comprises:
a first tap-quantity register that holds the number of taps in a first filter processing of an image;
a second tap-quantity register that holds the number of taps in a second filter processing of an image;
a first arithmetic-element-quantity register that holds the number of arithmetic logic units for the first filter processing;
a second arithmetic-element-quantity register that holds the number of arithmetic logic units for the second filter processing;
a first output size register that holds size of an execution result of the first filter processing;
a second output size register that holds size of an execution result of the second filter processing;
a first filter processing number-of-times calculator that calculates the number of times of the first filter processing from the number of taps in the second filter processing, the size of the execution result of the second filter processing, and the number of arithmetic logic units for the first filter processing;
a second filter processing number-of-times calculator that calculates the number of times of the second filter processing from the number of taps in the first filter processing, the size of the execution result of the first filter processing, and the number of arithmetic logic units for the second filter processing;
a first input size calculator that calculates the number of pieces of data which is input per cycle to the first register from the number of taps in the first filter processing, the number of times of the second filter processing, and the size of the execution result of the first filter processing; and
a second input size calculator that calculates the number of pieces of data which is input per cycle to the second register from the number of taps in the second filter processing, the number of times of the first filter processing, and the size of the execution result of the second filter processing.

8. The semiconductor device according to claim 7,
wherein the instruction decoder decodes an instruction which updates at least one of the first tap-quantity register, the second tap-quantity register, the first arithmetic-element-quantity register, the second arithmetic-element-quantity register, the first output size register, and the second output size register.
